(19) United States
(12) Patent Application Publication
(10) Pub. No.: US 2024/0330811 A1
(43) Pub. Date: Oct. 3, 2024

(54) SCENARIO GENERATION SYSTEM AND METHOD

(71) Applicant: Hitachi, Ltd., Tokyo (JP)

(72) Inventors: Nobuo NUKAGA, Tokyo (JP); Shigenori Matsumoto, Tokyo (JP); Hiromitsu Nakagawa, Tokyo (JP)

(73) Assignee: Hitachi, Ltd., Tokyo (JP)

(21) Appl. No.: 18/435,371

(22) Filed: Feb. 7, 2024

(30) Foreign Application Priority Data
Mar. 27, 2023 (JP) 2023-049766

(51) Int. Cl. G06Q 10/0631

(52) U.S. Cl. CPC G06Q 10/06316

(57) ABSTRACT

An effective scenario is generated for a target person of a scenario. A scenario generation system receives designation of a target person class. The system changes an order of two or more scenario element instances according to the designated target person class in a base scenario in which a plurality of scenario element instances are arranged to an order according to the designated target person class, and generates a proposed scenario including the two or more scenario element instances whose order is changed. The system provides the generated proposed scenario.

### BACKGROUND OF THE INVENTION

### 1. Field of the Invention

The present invention generally relates to generation of a scenario to be provided to a user.

### 2. Description of Related Art

It is known that a “scenario” contributes to an action (for example, decision-making) of a user (an individual or an organization). The user takes action according to the provided scenario.

Patent Literature 1 discloses a technique for deriving scenario candidates indicating latent needs of a user.

### CITATION LIST

### Patent Literature

PTL 1: JP2010-186283A

### SUMMARY OF THE INVENTION

However, in the technique disclosed in Patent Literature 1, a scenario is uniquely determined once a temporal order relation of elements such as actions and tasks is determined. Therefore, the possibility that the scenario is effective for a target person of the scenario is not high.

A scenario generation system receives designation of a target person class. The system changes an order of two or more scenario element instances according to the designated target person class in a base scenario in which a plurality of scenario element instances are arranged to an order according to the designated target person class, and generates a proposed scenario including the two or more scenario element instances whose order is changed. The system provides the generated proposed scenario.

According to the present invention, it is possible to generate an effective scenario for a scenario target person.

### BRIEF DESCRIPTION OF THE DRAWINGS

FIG. 1 shows a configuration example of a scenario generation system according to an embodiment of the present invention.

FIG. 2 shows an example of a base scenario input screen.

FIG. 3 shows a configuration example of a node table.

FIG. 4 shows a configuration example of a link table.

FIG. 5 shows a configuration example of an inter-label order relation table.

FIG. 6 shows a configuration example of an editing order table.

FIG. 7 shows a configuration example of a display order table.

FIG. 8 shows a base editing screen and display transition examples thereof.

FIG. 9 schematically shows an example of scenario generation.

FIG. 10 shows a configuration example of a scenario pattern table.

FIG. 11 shows a configuration example of a scenario skeleton table.

FIG. 12 shows an example of proposed scenario data.

FIG. 13 shows a flow of scenario generation processing.

FIG. 14 shows a specific example of base scenario data.

FIG. 15 shows a specific example of proposed scenario data.

FIG. 16 shows a flow of feedback processing.

FIG. 17 schematically shows an example of S1601 in FIG. 16.

FIG. 18 schematically shows an example of S1602 in FIG. 16.

### DESCRIPTION OF EMBODIMENTS

In the following description, an “interface device” may be one or more interface devices. The one or more interface devices may be at least one of the following.

One or more input/output (I/O) interface devices. The input/output (I/O) interface device is an interface device for at least one of an I/O device and a remote display computer. The I/O interface device for the display computer may be a communication interface device. The at least one I/O device may be a user interface device, for example, an input device such as a keyboard and a pointing device, or an output device such as a display device.

One or more communication interface devices. The one or more communication interface devices may be one or more communication interface devices of the same type (for example, one or more network interface cards (NICs)) or two or more communication interface devices of different types (for example, NIC and host bus adapter (HBA)).

In the following description, a “memory” is one or more memory devices, which are examples of one or more storage devices, and may be typically a main storage device. At least one memory device in the memory may be a volatile memory device or a non-volatile memory device.

In the following description, a “persistent storage device” may be one or more persistent storage devices, which are examples of one or more storage devices. The persistent storage device may be typically a non-volatile storage device (for example, an auxiliary storage device), and specifically, for example, a hard disk drive (HDD), a solid state drive (SSD), a non-volatile memory express (NVME) drive, or a storage class memory (SCM).

In the following description, a “processor” may be one or more processor devices. At least one processor device may be typically a microprocessor device such as a central processing unit (CPU), but may be another type of processor device such as a graphic processing unit (GPU). At least one processor device may be a single core or a multi-core. At least one processor device may be a processor core. At least one processor device may be a broadly defined processor device such as a circuit (for example, a field-programmable gate array (FPGA), a complex programmable logic device (CPLD), or an application specific integrated circuit (ASIC)) that is a collection of gate arrays in a hardware description language for performing a part or all the processing.

In the following description, functions may be described by an expression of “yyy unit”, and the functions may be implemented by one or more computer programs being executed by a processor, may be implemented by one or more hardware circuits (for example, FPGA or ASIC), or may be implemented by a combination thereof. When a function is implemented by a program being executed by a processor, the function may be at least a part of the processor as the specified processing is performed using a storage device and/or an interface device as appropriate. The processing described with a function as a subject may be the processing performed by a processor or a device including the processor. The program may be installed from a program source. The program source may be, for example, a program distribution computer or a computer-readable recording medium (for example, a non-transitory recording medium). The description of the functions is an example, and a plurality of functions may be integrated into one function, or one function may be divided into a plurality of functions.

In the following description, expressions such as “xxx DB” (“DB” is an abbreviation for database) and “xxx table” may be used to explain data that provides an output for an input, and the data may have any structure (for example, the data may be structured data or unstructured data), or may be a learning model such as a neural network, genetic algorithm, or random forest that generates an output based on an input. Therefore, “xxx DB” and “xxx table” can be referred to as “xxx data”. In the following description, configurations of DBs and tables are examples, and one DB or table may be divided into two or more DBs or tables, or all or a part of two or more DBs or tables may be one DB or table.

In addition, in the following description, when elements of the same type are described without being distinguished, a common reference numeral may be used, and when elements of the same type are distinguished and described, reference numerals may be used.

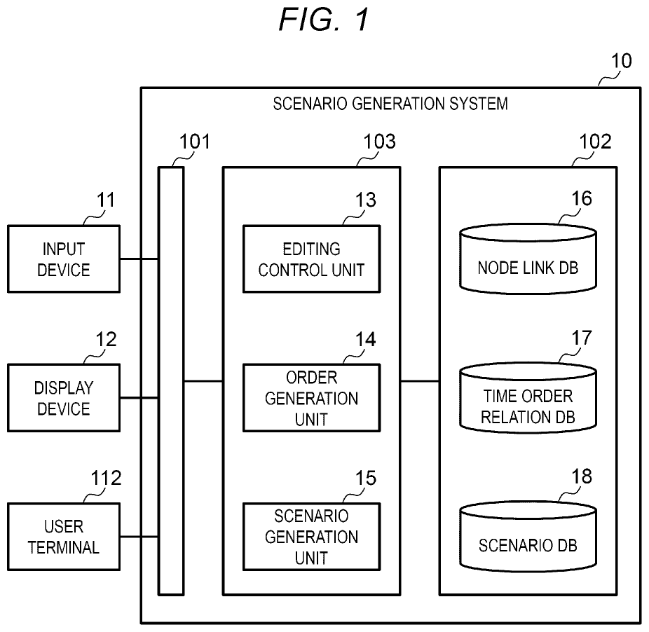

FIG. 1 shows a configuration example of a scenario generation system according to an embodiment of the present invention.

A scenario generation system 10 includes an interface device 101, a storage device 102, and a processor 103 connected to the interface device 101 and the storage device 102. In the present embodiment, the scenario generation system 10 is a physical computer system (a system including one or more physical computers), but may be a logical computer system (for example, a cloud computing system) based on a physical computer system.

An input device 11 and a display device 12 may be connected to the interface device 101, or a user terminal 112 (for example, an information processing terminal such as a personal computer or a smartphone) may be connected to the interface device 101. The scenario generation system 10 may receive an input of information from the input device 11 or the user terminal 112. The scenario generation system 10 may display information on the display device 12 or the user terminal 112.

The storage device 102 stores data and programs. For example, the storage device 102 stores a node link DB 16, a time order relation DB 17, and a scenario DB 18. The node link DB 16 includes a node table, a link table, an editing order table, a display order table, and an inter-label order relation table, which will be described later. The time order relation DB 17 includes time order relation data, which will be described later. The scenario DB 18 includes a scenario pattern table, a scenario skeleton table, and dynamically generated scenario data, which will be described later.

When the processor 103 executes programs stored in the storage device 102, functions such as an editing control unit 13, an order generation unit 14, and a scenario generation unit 15 are implemented.

FIG. 2 schematically shows an example of a base scenario input screen 200.

The base scenario input screen 200 is an input screen of a base scenario (a base of a scenario to be generated and proposed). In the present embodiment, a scenario is represented by a graph including nodes and links.

The base scenario input screen 200 is displayed on the display device 12 or the user terminal 112 by the editing control unit 13. In a graph input to the base scenario input screen 200, a node corresponds to a scenario element (specifically, a scenario element as an instance), and a link represents a relation (for example, an order) between scenario elements. In addition, the graph may include a plurality of layers, and a layer label (for example, a “management issue”, a “business issue”, or a “solution”) is input for each layer.

In FIG. 2, reference numerals assigned to each node, link, and layer are IDs of the node, link, and the layer. The IDs may or may not be actually displayed.

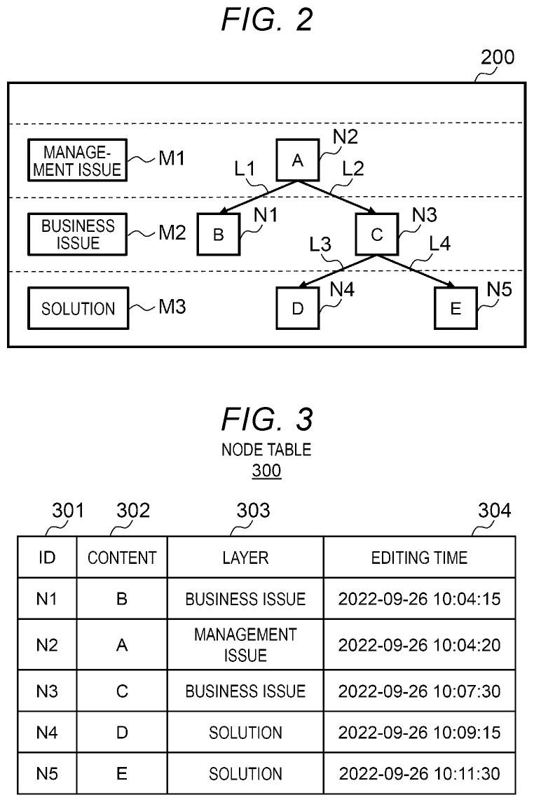

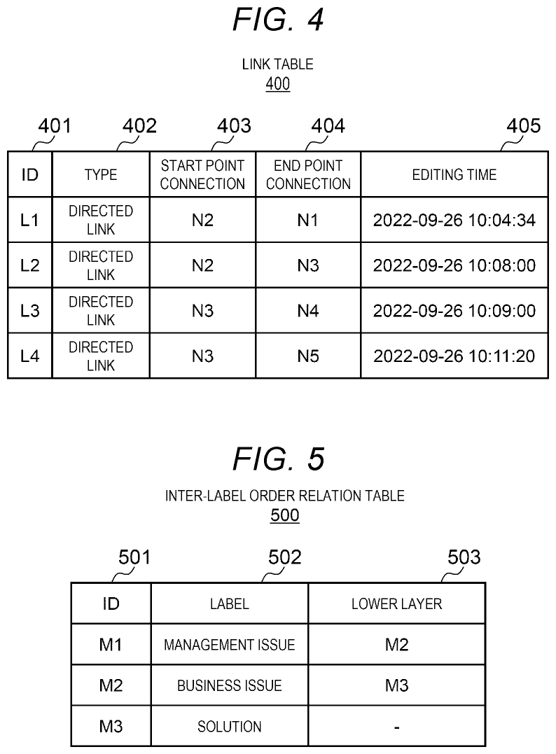

Data representing the graph input to the base scenario input screen 200 is stored in the node link DB 16 as the node table 300 (see FIG. 3), the link table 400 (see FIG. 4), and the inter-label order relation table 500 (see FIG. 5) by the editing control unit 13.

FIG. 3 shows a configuration example of the node table 300.

The node table 300 includes information for each node. For example, the node table 300 has a record including information such as an ID 301, a content 302, a layer 303, and an editing time 304 for each node.

The ID 301 represents an ID of a node. The content 302 represents a content (instance) as a scenario element belonging to the node. The layer 303 represents a label of a layer to which the node belongs. The editing time 304 represents a time when the node (for example, a text as a scenario element corresponding to the node) is edited. In the present embodiment, the unit of time may be year, month, day, hour, minute, second, or may be coarser or finer than that.

FIG. 4 shows a configuration example of the link table 400.

The link table 400 includes information for each link. For example, the link table 400 has a record including information such as an ID 401, a type 402, a start point connection 403, an end point connection 404, and an editing time 405 for each link.

The ID 401 represents an ID of a link. The type 402 represents a type of the link (for example, a directed link or an undirected link). The start point connection 403 represents an ID of a node at one end (start point) of the link. The end point connection 404 represents an ID of a node at the other end (end point) of the link. The editing time 405 represents the time when the link is edited.

FIG. 5 shows a configuration example of the inter-label order relation table 500.

The inter-label order relation table 500 represents an order of layers of a graph. For example, the inter-label order relation table 500 has a record including information such as an ID 501, a label 502, and a lower layer 503 for each layer.

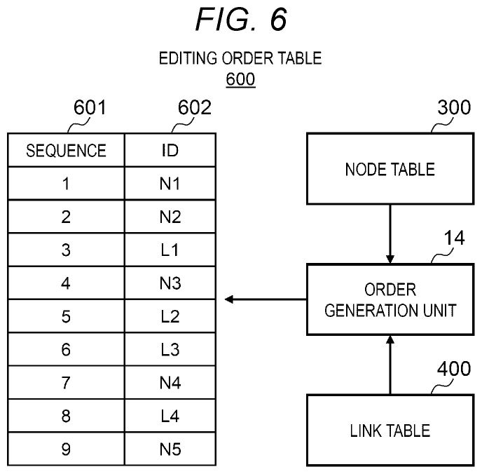

The ID 501 represents an ID of a layer. The label 502 represents a label of the layer. The lower layer 503 represents an ID of a layer immediately below the layer. FIG. 6 shows a configuration example of an editing order table 600.

The editing order table 600 represents an editing order of nodes and links. Specifically, the editing order table 600 has a record including information such as a sequence 601 and an ID 602 for each node or link.

The sequence 601 represents a sequence of editing times of nodes or links. The ID 602 represents an ID of a node or a link. According to the illustrated example, records are arranged in ascending order of the sequence 601 (chronological order of editing time). Specifically, it can be seen that nodes or links are edited in an order of N1 to N2 to L1 to . . . according to the illustrated example.

The editing order table 600 is generated by the order generation unit 14. Specifically, the order generation unit 14 specifies the editing time of nodes or links based on the node table 300 and the link table 400, and generates the editing order table 600 in which IDs of the nodes or links are arranged in the chronological order of the editing time. The order generation unit 14 stores the generated editing order table 600 in the node link DB 16. The editing order table 600 may be a temporary table.

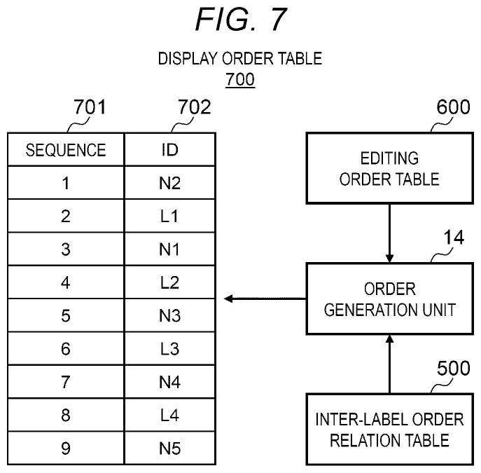

FIG. 7 shows a configuration example of a display order table 700.

The display order table 700 represents a display order of nodes and links. Specifically, the display order table 700 has a record including information such as a sequence 701 and an ID 702 for each node or link.

The sequence 701 represents a sequence in which nodes or links are displayed. The ID 702 represents an ID of a node or a link. According to the illustrated example, records are arranged in ascending order of the sequence 701. Specifically, it can be seen that nodes or links are displayed in an order of N2 to L1 to N1 to . . . according to the illustrated example.

The display order table 700 is generated by the order generation unit 14. Specifically, the order generation unit 14 specifies the order between layers based on the inter-label order relation table 500, and arranges the order represented by the editing order table 600 to the specified order between layers (between labels). The order generation unit 14 generates the display order table 700 representing the arranged order as a display order, and stores the generated display order table 700 in the node link DB 16. The display order table 700 may be a temporary table. The order generation unit 14 may specify which node belongs to which layer based on the node table 300, and may arrange the editing order of nodes or links to the display order of nodes or links based on relations between nodes and layers.

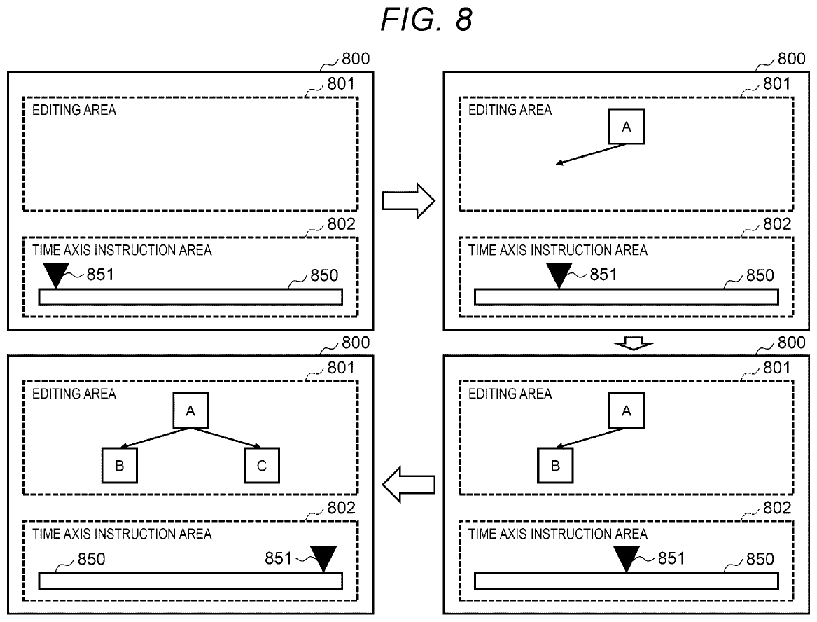

FIG. 8 shows a scenario editing screen and display transition examples thereof.

The scenario editing screen 800 is a screen used for editing a scenario. The scenario editing screen 800 is displayed on the display device 12 or the user terminal 112 by the editing control unit 13. The scenario editing screen 800 includes an editing area 801 and a time axis instruction area 802.

In the editing area 801, a graph representing a scenario is displayed, and the displayed graph is edited by a user. According to the editing of the graph, the editing control unit 13 updates the node table 300, the link table 400, or the inter-label order relation table 500.

A time axis 850 and an indicator 851 are displayed in the time axis instruction area 802. A direction from a left end (start point) to a right end (end point) of the time axis 850 means the progress of time. A position of the indicator 851 on the time axis 850 means a time point. The adjustment of a relation between a node or a link and the position of the indicator 851 may be an example of editing the display order.

According to the illustrated examples, all or a part of graphs representing scenarios are displayed by animation. That is, the indicator 851 advances in animation from the left end to the right end of the time axis 850, and the graph is displayed in animation according to the advance of the position of the indicator 851. The display order of nodes or links in the graph follows the display order table 700. In the display order table 700, in addition to the sequence 701 and the ID 702, a display timing of a node or a link (for example, an offset from the start point of the time axis 850) may be recorded for each node or link.

After a base scenario is input or edited through the base scenario input screen 200 or the scenario editing screen 800, a proposed scenario is dynamically generated based on the base scenario.

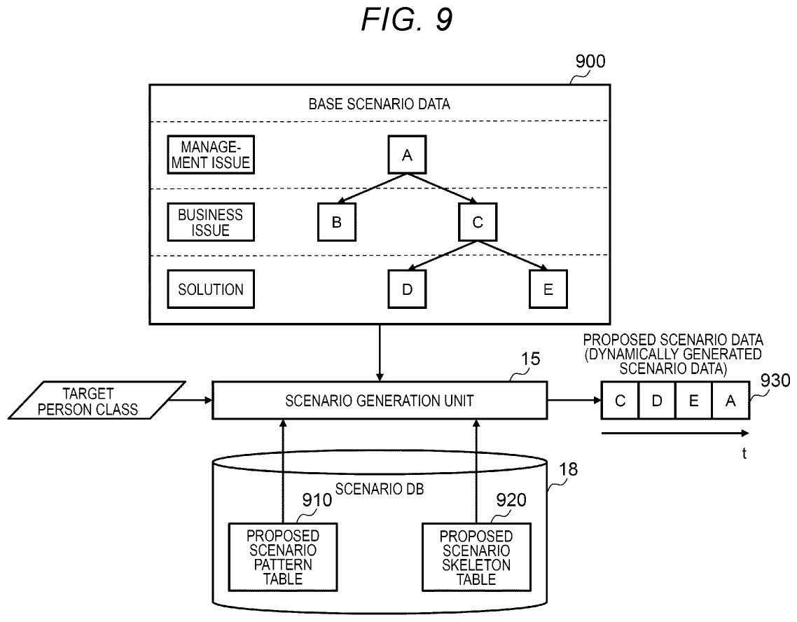

FIG. 9 schematically shows an example of generating a proposed scenario.

The scenario generation unit 15 receives designation of a target person class from a user. A “target person” refers to a user to which the proposed scenario is provided, and the “target person class” refers to an attribute (for example, a job title, a business type, or the like) of the target person. A plurality of target person classes may be defined in advance, and the target person class designated by the user may be a target person class selected from the plurality of target person classes.

The scenario generation unit 15 generates proposed scenario data 930 based on the designated target person class, a scenario pattern table 910, a scenario skeleton table 920, and base scenario data 900. The scenario generation unit 15 provides a scenario (proposed scenario) represented by the proposed scenario data 930.

The base scenario data 900 is data including at least a part of the node table 300, the link table 400, the inter-label order relation table 500, the editing order table 600, and the display order table 700 corresponding to the input or edited base scenario.

In the proposed scenario data 930, a plurality of nodes (a plurality of scenario elements) in a graph represented by the base scenario data 900 and an order of the nodes are defined. The node order represented by the proposed scenario data 930 is different from a node order represented by the base scenario data 900. Specifically, according to the base scenario data 900, the node order is A to C to D to E (D and E may be simultaneous), but according to the proposed scenario data 930, the node order is C to D to E to A. In this manner, the node order represented by the base scenario data 900 is changed to a node order appropriate for the target person class, and a proposed scenario including nodes (scenario elements) that follow the changed node order is provided.

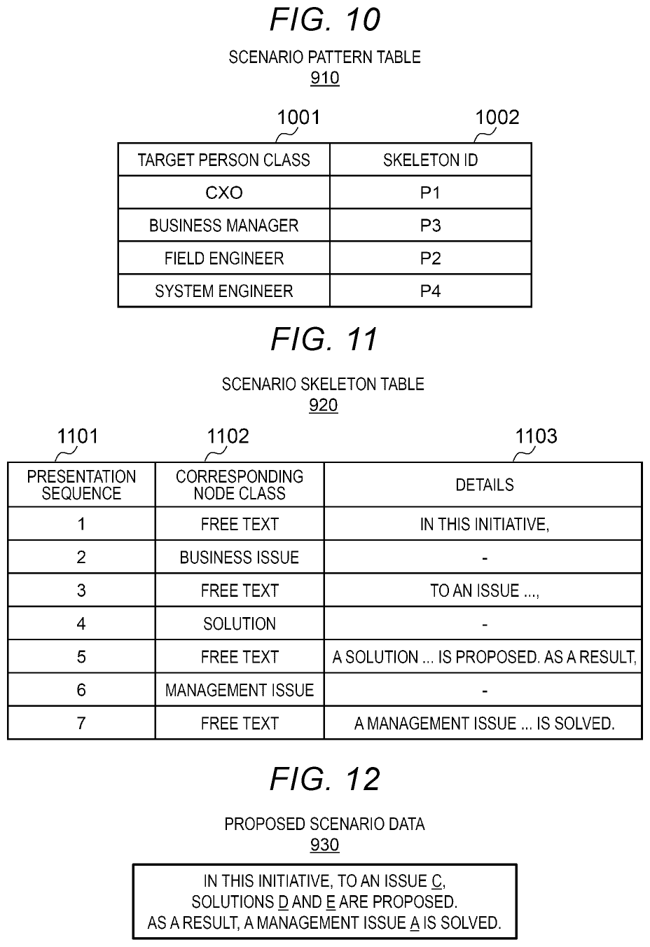

FIG. 10 shows a configuration example of the scenario pattern table 910.

The scenario pattern table 910 has a record including information such as a target person class 1001 and a skeleton ID 1002 for each target person class.

The target person class 1001 represents a target person class. The skeleton ID 1002 represents an ID of the scenario skeleton table 920.

FIG. 11 shows a configuration example of the scenario skeleton table 920.

The scenario skeleton table 920 represents a scenario skeleton and is prepared for each target person class that can be designated. The illustrated scenario skeleton table 920 corresponds to a target person class “business manager” shown in FIG. 10. Specifically, in the illustrated scenario skeleton table 920, a skeleton ID “P3” corresponding to the target person class “business manager” is associated.

The scenario skeleton table 920 has a record including information such as a presentation sequence 1101, a corresponding node class 1102, and details 1103 for each scenario element (element set in a proposed scenario).

The presentation sequence 1101 represents a sequence of positions in the proposed scenario of scenario elements. The lower the sequence, the closer a scenario element is arranged to the head of the proposed scenario.

The corresponding node class 1102 represents a node class corresponding to a scenario element. A “node class” means a label of a layer to which a node corresponding to a scenario element belongs, or a data type (for example, text, image, or figure) of a scenario element in a proposed scenario.

The details 1103 represent details of a scenario element. Specifically, for example, a value of the details 1103 corresponding to the corresponding node class 1102 “free text” is a text as a scenario element. In addition, for example, the value of the details 1103 where the corresponding node class 1102 corresponds to a label of a layer is a value (for example, “-”) meaning all nodes belonging to the layer or a value (for example, “{C}”) meaning a node set in a proposed scenario among the nodes belonging to the layer. In the latter case, a content (the content 302 (see FIG. 3)) of the node is set in the proposed scenario. In a case where a node is uniquely determined without designation of a node based on a structure of a graph represented by the base scenario data 900 and a configuration of a scenario skeleton represented by the scenario skeleton table 920, the designation of a node may be omitted. For example, according to the graph shown in FIG. 2 and the scenario skeleton shown in FIG. 11, among the nodes that belong to the layer “business issue”, since only a node C has a node that belongs to the layer “solution” as a child node, the node C can be uniquely specified even if there is no value that means the node C as the value of details 1103.

FIG. 12 shows an example of the proposed scenario data 930.

The proposed scenario data 930 is data representing a proposed scenario. The proposed scenario represented by the illustrated proposed scenario data 930 is data created based on the scenario skeleton table 920 shown in FIG. 11. In FIG. 11, the underline indicates a value of the content 302 of a node.

Hereinafter, an example of processing performed in the present embodiment will be described.

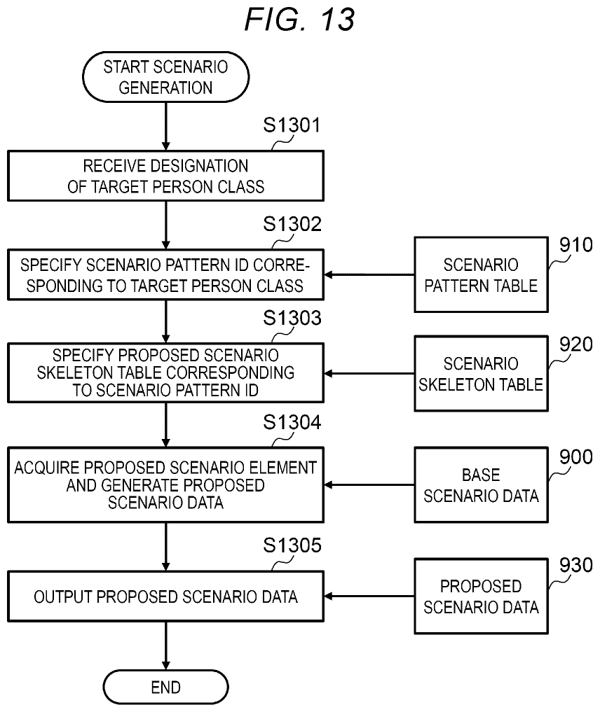

FIG. 13 shows a flow of scenario generation processing.

The scenario generation unit 15 receives designation of a target person class desired by a user among a plurality of target person classes (for example, target person classes described in the scenario pattern table 910) (S1301). S1301 may be, for example, reception of a scenario request in which a target person class is designated. The scenario generation unit 15 specifies a skeleton ID corresponding to the target person class designated in S1301 from the scenario pattern table 910 (S1302). The scenario generation unit 15 specifies the scenario skeleton table 920 corresponding to the skeleton ID from a scenario skeleton table associated with the skeleton ID specified in S1302 (S1303).

The scenario generation unit 15 acquires a plurality of scenario elements (for example, texts as values of the details 1103 of the table 920 and texts as values of the content 302 of nodes) from the table 920 and the base scenario data 900 according to the scenario skeleton table 920 specified in S1303, and generates the proposed scenario data 930 representing a proposed scenario in which the plurality of scenario elements are arranged in ascending order of the presentation sequence 1101 (S1304).

The scenario generation unit 15 outputs the proposed scenario data 930 generated in S1304 (S1305). The output of the proposed scenario data 930 may be, for example, providing (displaying) the proposed scenario represented by the proposed scenario data 930 to the user who designates the target person class in S1301. The proposed scenario provided may be edited by the user. The proposed scenario data 930 generated in S1304 or the proposed scenario data 930 representing the proposed scenario edited by the user may be stored in the scenario DB 18.

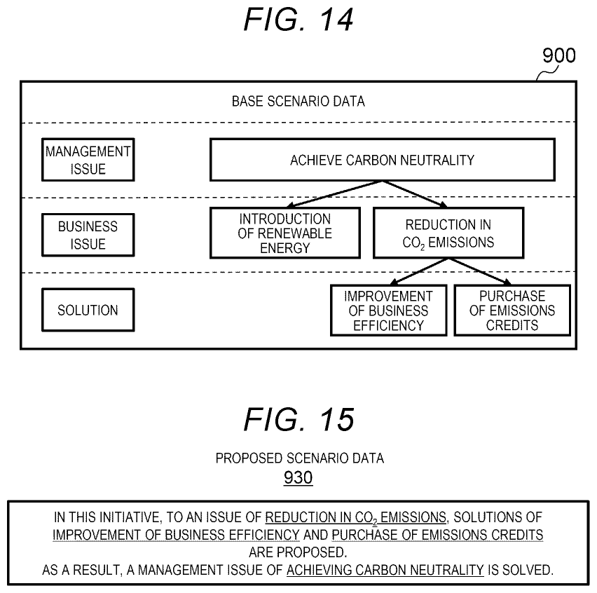

In the processing shown in FIG. 13, it is assumed that the graph shown in FIG. 2 is as shown in FIG. 14. That is, it is assumed that the graph represented by the base scenario data 900 is as shown in FIG. 14. It is also assumed that a “business manager” is selected as the target person class in S1301. Therefore, the scenario skeleton table 920 specified in S1303 is as shown in FIG. 11. In this case, the generated proposed scenario data 930 is as shown in FIG. 15. That is, for a corresponding node class (layer) “business issue” corresponding to the presentation sequence “2”, the node “reduction in CO2 emissions” is specified and set in the proposed scenario.

The scenario skeleton table 920 may be manually edited by the user, or a part or all of the scenario skeleton table 920 may be automatically edited. Feedback processing is one method for automatic editing. In the feedback processing, by feeding back a provision result of a proposed scenario (whether the proposed scenario is adopted by a user), it is possible to prepare a more appealing scenario skeleton table 920 as the scenario skeleton table 920 on which the proposed scenario is created.

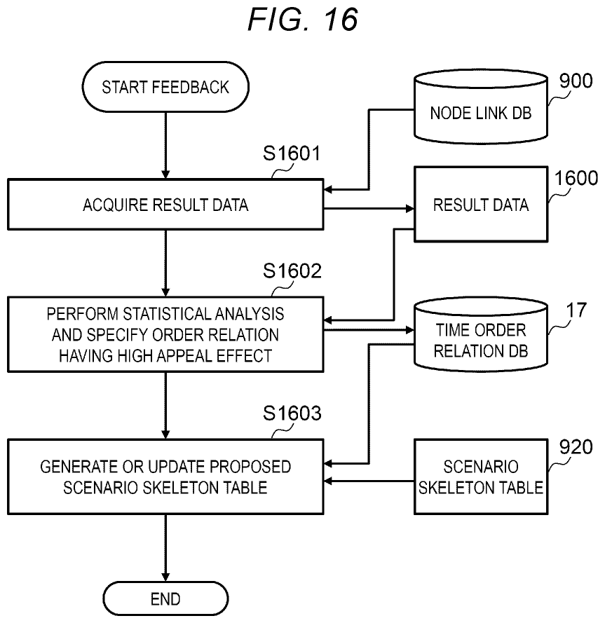

FIG. 16 shows a flow of the feedback processing.

The order generation unit 14 acquires the result data 1600 from the node link DB 16 (S1601).

The order generation unit 14 performs analysis (for example, statistical analysis) using a scenario summary table which will be described later in the node link DB 16 and the result data 1600, specifies an order relation having a high appeal effect, and stores time order relation data representing the specified order relation in the time order relation DB 17 (S1602).

The order generation unit 14 newly generates, based on the time order relation data stored in S1602, the scenario skeleton table 920 based on the existing scenario skeleton table 920, or updates the existing scenario skeleton table 920 (S1603).

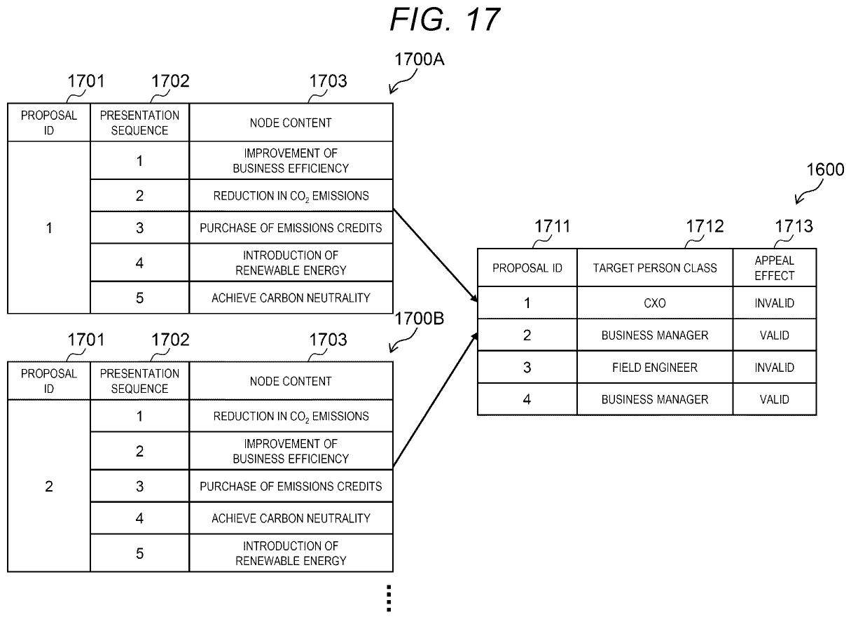

FIG. 17 schematically shows an example of S1601 in FIG. 16.

A scenario summary table 1700 is stored in the node link DB 16 by the scenario generation unit 15 for each proposed scenario provided. The scenario summary table 1700 has a proposal ID 1701, and also has information such as a presentation sequence 1702 and a node content 1703 for each scenario element (node content) in the proposed scenario.

The proposal ID 1701 represents an ID of a proposed scenario. The presentation sequence 1702 indicates a sequence (the first being “1”, which is the smallest sequence) in the proposed scenario of the scenario element (node content). The node content 1703 represents the node content of the scenario element.

The result data 1600 is, for example, a table, created by the scenario generation unit 15, and stored in the node link DB 16. The result data 1600 includes a record including information such as a proposal ID 1711, a target person class 1712, and an appeal effect 1713 for each provided proposal.

The proposal ID 1711 represents an ID of a proposed scenario. The target person class 1712 represents a target person class corresponding to the proposed scenario. The appeal effect 1713 represents whether the proposed scenario is adopted (“valid” or “invalid”).

The scenario generation unit 15 generates the scenario summary table 1700 based on the proposed scenario data 930 for the provided proposed scenario, and stores the scenario summary table 1700 in the node link DB 16. The scenario generation unit 15 receives an appeal effect, which is whether the proposed scenario is adopted, via a user interface (for example, a graphical user interface (GUI)) from a user to which the proposed scenario is provided. The scenario generation unit 15 includes, in the result data 1600, an ID of the proposed scenario, a target person class corresponding to the proposed scenario, and information indicating the received appeal effect.

In S1601 of FIG. 16, the order generation unit 14 acquires the result data 1600 from the node link DB 16.

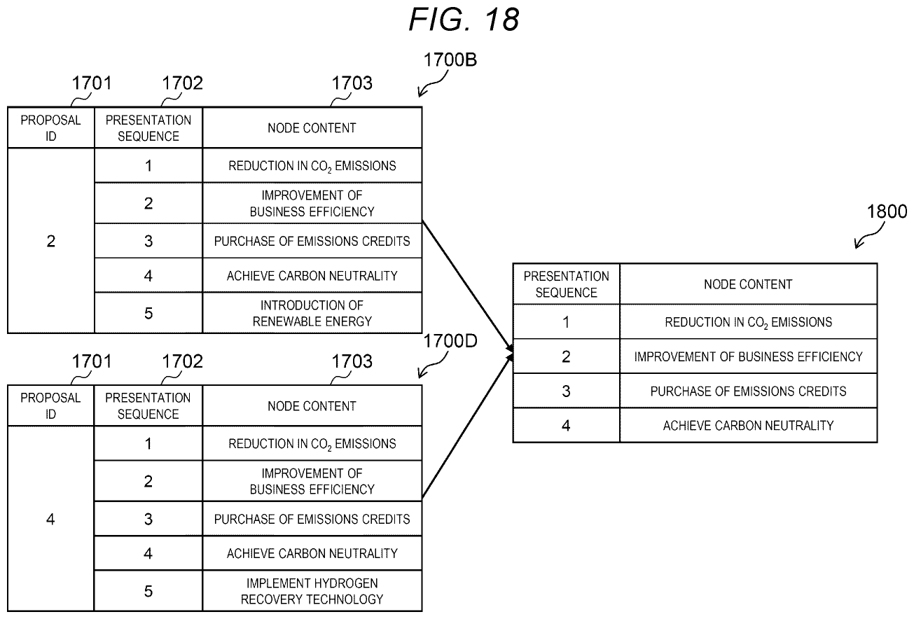

FIG. 18 schematically shows an example of S1602 in FIG. 16.

The order generation unit 14 acquires a plurality of scenario summary tables 1700 (for example, 1700B and 1700D) corresponding to the appeal effect 1713 “valid” for the same target person class (for example, “business manager”) from the node link DB 16, and extracts a common information pair (a pair of the presentation sequence 1702 and the node content 1703) from the plurality of scenario summary tables 1700. The order generation unit 14 generates time order relation data 1800, which is data constituted by the extracted information pair, and stores the time order relation data 1800 in the time order relation DB 17.

In subsequent S1603, the order generation unit 14 newly generates, based on the time order relation data 1800 and the existing scenario skeleton table 920 associated with a target person class (for example, “business manager”) corresponding to the time order relation data 1800, the scenario skeleton table 920 or updates the existing scenario skeleton table 920. Specifically, for example, the generated or updated scenario skeleton table 920 has node contents arranged in the order of the presentation sequence represented by the time order relation data 1800.

The order generation unit 14 may acquire a plurality of scenario summary tables 1700 corresponding to the appeal effect 1713 “valid” from the node link DB 16 regardless of whether the target person class is the same, and generate the time order relation data 1800 based on the common information pair extracted from the plurality of scenario summary tables 1700.

Although one embodiment has been described above, this embodiment is an example for describing the present invention, and the scope of the present invention is not limited to this embodiment. The present invention can be implemented in various other forms.

The above description can be summarized as follows, for example. The following summary may include a supplementary description and a description of modifications to the above.

The scenario generation system 10 includes the interface device 101, the storage device 102, and the processor 103 connected to the interface device 101 and the storage device 102. The storage device 102 stores the base scenario data 900 including data representing a base scenario (for example, a graph in which scenario element instances are nodes and relations between the scenario element instances are links) representing an arrangement of a plurality of scenario element instances. The processor 103 receives designation of a target person class through the interface device 101. The processor 103 changes an order of two or more scenario element instances according to the designated target person class among the plurality of scenario element instances represented by the base scenario data to an order according to the designated target person class, and generates a proposed scenario including the two or more scenario element instances whose order is changed. The processor 103 provides the generated proposed scenario through the interface device 101. The proposed scenario has two or more scenario element instances arranged in the order corresponding to the target person class, and the two or more scenario element instances correspond to the target person class. In this manner, an effective proposed scenario is generated for a target person of a scenario. As an example of an effective proposed scenario, a highly convincing scenario that contributes to the achievement of an object such as contract agreement or order acquisition as a result of action according to the proposed scenario may be used.

The storage device 102 may store the scenario skeleton table 920 (an example of scenario skeleton data) representing a scenario skeleton for each of a plurality of target person classes. For each of the plurality of target person classes, the scenario skeleton may include a plurality of scenario element parameters (for example, parameters in which node contents are instances) and scenario elements (for example, texts) that associate the scenario element parameters. The processor 103 may specify a scenario skeleton table 920 corresponding to the designated target person class from the storage device 102 and set a scenario element instance corresponding to a scenario element parameter for each scenario element parameter in the scenario skeleton represented by the specified scenario skeleton table 920, thereby generating a proposed scenario. In this manner, a proposed scenario is generated in which two or more scenario element instances corresponding to the designated target person class are arranged in an order corresponding to the target person class.

Both the scenario element instance set in the scenario element parameter and scenario elements between the scenario element parameters may be texts. As a result, a proposed scenario can be provided as a sentence.

The storage device 102 may store the result data 1600. The result data 1600 may include, for each proposed scenario, a target person class corresponding to the proposed scenario and whether the proposed scenario is adopted. The processor 103 may specify, based on the result data 1600, common information among a plurality of proposed scenarios adopted for the same target person class (for example, may specify a common information pair as common information from a plurality of scenario summary tables 1700 corresponding to the plurality of proposed scenarios). The processor 103 may generate or update, based on a scenario skeleton table 920 corresponding to the same target person class and the specified common information, the scenario skeleton table 920 corresponding to the target person class. As a result, it is expected to generate a proposed scenario having a higher appeal effect for the target person class.

The processor 103 may determine a display order based on an editing order of nodes and links in a graph and a plurality of layers of the graph, and display the nodes and links of the graph represented by the base scenario data 900 in the determined display order in animation through the interface device 101. This can be expected to improve the editing efficiency of a base scenario.

What is claimed is:

1. A scenario generation system comprising:
an interface device;
a storage device; and
a processor connected to the interface device and the storage device, wherein
the storage device stores base scenario data including data representing a base scenario representing an arrangement of a plurality of scenario element instances, and
the processor receives designation of a target person class through the interface device, changes an order of two or more scenario element instances according to the designated target person class among the plurality of scenario element instances represented by the base scenario data to an order according to the designated target person class, generates a proposed scenario including the two or more scenario element instances whose order is changed, and provides the generated proposed scenario through the interface device.

2. The scenario generation system according to claim 1, wherein
the storage device stores scenario skeleton data representing a scenario skeleton for each of a plurality of target person classes,
the scenario skeleton for each of the plurality of target person classes includes a plurality of scenario element parameters and scenario elements that associate the scenario element parameters, and
the processor specifies scenario skeleton data corresponding to the designated target person class from the storage device, and sets, for each scenario element parameter in a scenario skeleton represented by the specified scenario skeleton data, a scenario element instance corresponding to the scenario element parameter, to generate the proposed scenario.

3. The scenario generation system according to claim 2, wherein
both the scenario element instance set in the scenario element parameter and the scenario elements between the scenario element parameters are texts.

4. The scenario generation system according to claim 2, wherein
the storage device stores result data,
the result data including, for each proposed scenario, a target person class corresponding to the proposed scenario and whether the proposed scenario is adopted, and
the processor specifies, based on the result data, common information among a plurality of proposed scenarios adopted for a same target person class, and generates or updates, based on scenario skeleton data corresponding to the same target person class and the specified common information, the scenario skeleton data corresponding to the target person class.

5. The scenario generation system according to claim 1, wherein
the storage device stores result data,
the result data including, for each proposed scenario, a target person class corresponding to the proposed scenario and whether the proposed scenario is adopted,
the processor specifies, based on the result data, common information among a plurality of proposed scenarios adopted for a same target person class, and
the two or more scenario element instances and an order thereof for the same target person class are based on the specified common information.

6. The scenario generation system according to claim 1, wherein
the base scenario is a graph in which the scenario element instances are nodes and relations between the scenario element instances are links,
the processor determines a display order based on an editing order of the nodes and the links in the graph and a plurality of layers included in the graph, and
the processor displays the nodes and the links in the graph represented by the base scenario data in animation in the determined display order through the interface device.

7. A scenario generation method comprising:
a computer receiving designation of a target person class;
the computer changing an order of two or more scenario element instances according to the designated target person class in a base scenario in which a plurality of scenario element instances are arranged to an order according to the designated target person class, and generating a proposed scenario including the two or more scenario element instances whose order is changed; and
the computer providing the generated proposed scenario.

8. A computer program causing a computer to execute:
receiving designation of a target person class;
changing an order of two or more scenario element instances according to the designated target person class in a base scenario in which a plurality of scenario element instances are arranged to an order according to the designated target person class, and generating a proposed scenario including the two or more scenario element instances whose order is changed; and
providing the generated proposed scenario.
